(19) United States
(12) Patent Application Publication
(10) Pub. No.: US 2004/0256326 A1
(43) Pub. Date: Dec. 23, 2004

(54) System and process for decontaminating soil

(76) Inventors: Michael J. Hannon, Worcester, MA (US); Denis W. D'Amore, Lancaster, MA (US)

Correspondence Address: Brian M. Dingman, Mirick, O'Connell, DeMallie & Lougee, LLP, 1700 West Park Drive, Westborough, MA, 01581-3941, US

(21) Appl. No.: 10/862,100

(22) Filed: Jun. 4, 2004

Related U.S. Application Data
(60) Provisional application No. 60/475,746, filed on Jun. 4, 2003.

(51) Int. Cl. C02F 1/24

(52) U.S. Cl. 210/703

(57) ABSTRACT

A process for removing hydrocarbon contaminants from contaminated soil. One or more additives comprising solutions of one or more of alcohols and polyols are added to the soil, and the soil/additive mixture is stirred. This causes the contaminants to be at least partially removed from the soil. At least some of the hydrocarbon contaminants are removed from the mixture by flotation, and recovered by skimming.

### CROSS REFERENCE TO RELATED APPLICATION

This application claims priority of Provisional application Ser. No. 60/475,746, filed on Jun. 4, 2003.

### FIELD OF THE INVENTION

This invention relates to a process for removing hydrocarbon contaminants from soil.

### BACKGROUND OF THE INVENTION

Hydrocarbon contamination of soil has proven to be a difficult environmental problem. Many types of hydrocarbon contaminants need to be removed from soil, including gasoline, diesel fuel, and PCBs, for example. Volatile contaminants can sometimes be removed on-site. Nonvolatile contaminants are typically removed off-site. Off-site contaminant removal processes are typically complex and expensive, using sophisticated equipment and chemicals that themselves can be volatile or dangerous. Accordingly, there is a need for a process for remediating hydrocarbon contaminants from contaminated soil that is simple, inexpensive and not harmful to the environment.

### SUMMARY OF THE INVENTION

It is therefore an object of this invention to accomplish a process for removing hydrocarbons from contaminated soil. The process is simple, involves very few steps, and can be accomplished with simple, readily-available equipment. The process does not use any chemicals that are unusual or dangerous to store or use, or that themselves require any unusual treatment. In addition, in many cases the separated hydrocarbons can be reused or at least burned for energy recovery.

This invention features a process for removing hydrocarbon contaminants from contaminated soil, comprising adding to the soil at least one additive selected from the group consisting of alcohols and polyols, mixing, to contact the components together, to cause the contaminants to be at least partially removed from the soil by the additives, and removing at least some of the hydrocarbon contaminants by flotation. The process may further comprise adding cell-containing plastic particles before the mixing step. The plastic particles may comprise mechanically-ground foamed polystyrene. The plastic, when used, is preferably open-celled.

The additive may comprise a methanol-based solution, which may have a concentration in the range of about 1 to about 12 percent. Alternatively, the additive may comprise an ethanol-based solution, which may have a concentration in the range of about 1 to about 60 percent. The additive may comprise a propylene glycol-based solution, or a glycerin-based solution. The additive may comprise a solution of ethanol, glycol and glycerine.

Also featured is a process for removing hydrocarbon contaminants from contaminated soil, comprising adding to the soil at least one additive selected from the group consisting of methanol-based and ethanol-based solutions, mixing, to contact the components together, to cause the contaminants to be at least partially removed from the soil by the additives, stirring the soil-additive mixture in a water bath to cause at least some of the hydrocarbon contaminants to float to the top of the water bath, and removing floating contaminants from the water bath.

### BRIEF DESCRIPTION OF THE DRAWINGS

FIG. 1 is a schematic diagram of the preferred embodiment of the equipment for the process of the invention;

FIGS. 2A and 2B depict the preferred mixer for the process of FIG. 1;

FIGS. 3A, 3B and 3C depict the preferred separator for the process of FIG. 1;

FIGS. 4A and 4B depict the preferred screw conveyor for the process of FIG. 1; and

FIG. 5 is a flowchart of the preferred process of the invention.

### PREFERRED EMBODIMENT OF THE INVENTION

This invention comprises a system and process for decontaminating contaminated soil. The process is particularly suited to remove petroleum hydrocarbons (typically fuels and PCBs) from soil. Broadly, the process involves mixing the contaminated soil with a liquid activator (and optionally plastic particles). The activator helps to dissociate the contaminants from the soil. When plastic particles are used, the contaminants can be preferentially attracted to the plastic particles. The dissociated contaminants, or plastic particles carrying the contaminants, can then be separated from the soil, leaving soil that is less contaminated.

In the data set forth below, the contaminants were hydrocarbons, including gasoline, diesel fuel, waste oil, and PCBs. The liquid additives or activators used were alcohols and polyols, including ethanol, methanol, propylene glycol, and glycerin USP. The plastic used in some examples was foamed polystyrene, mechanically ground into rice-sized particles to expose its cells and increase its surface area available for adsorption of the contaminants.

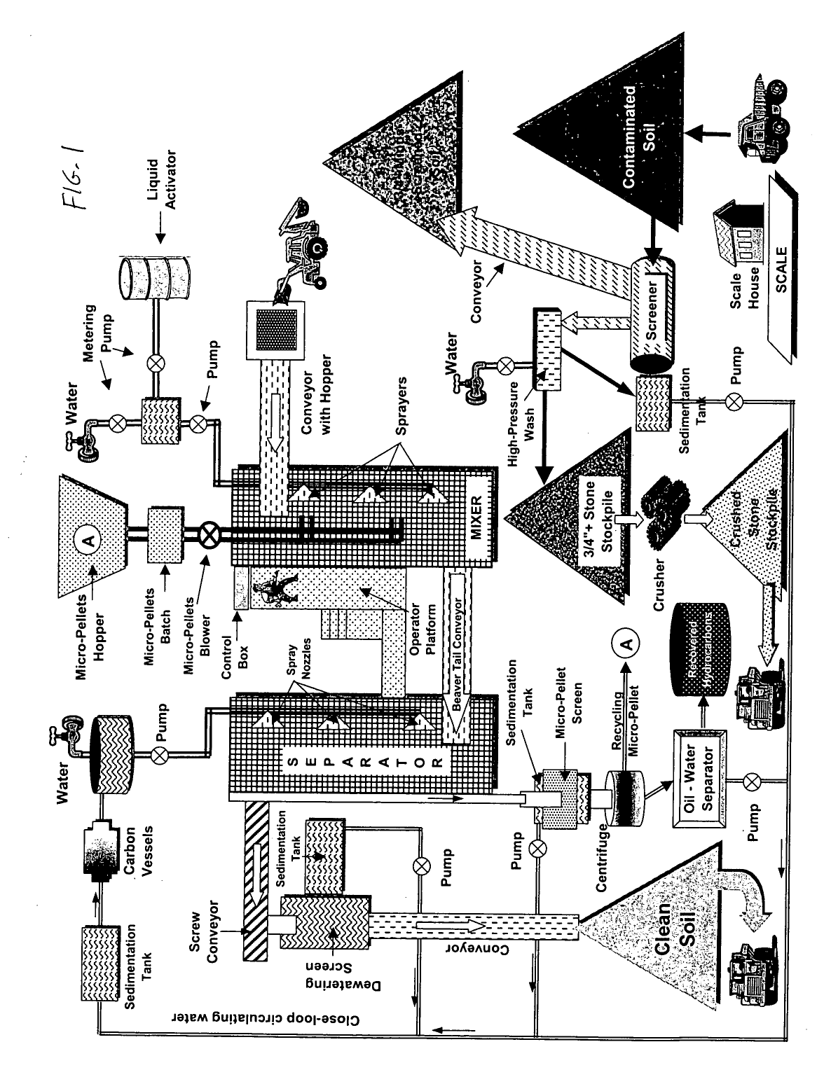

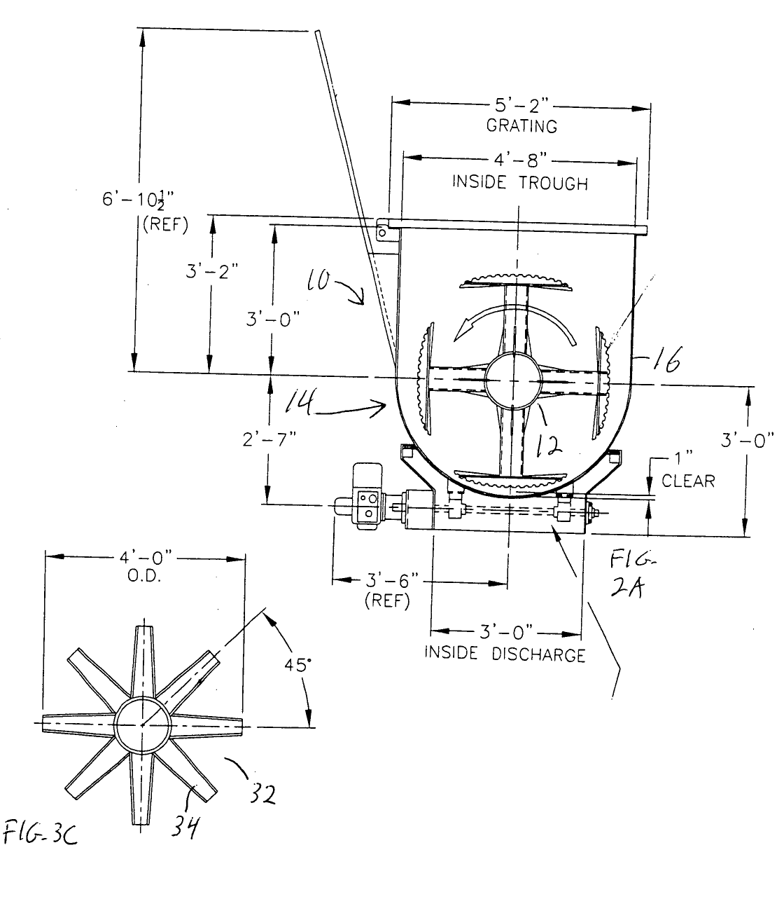

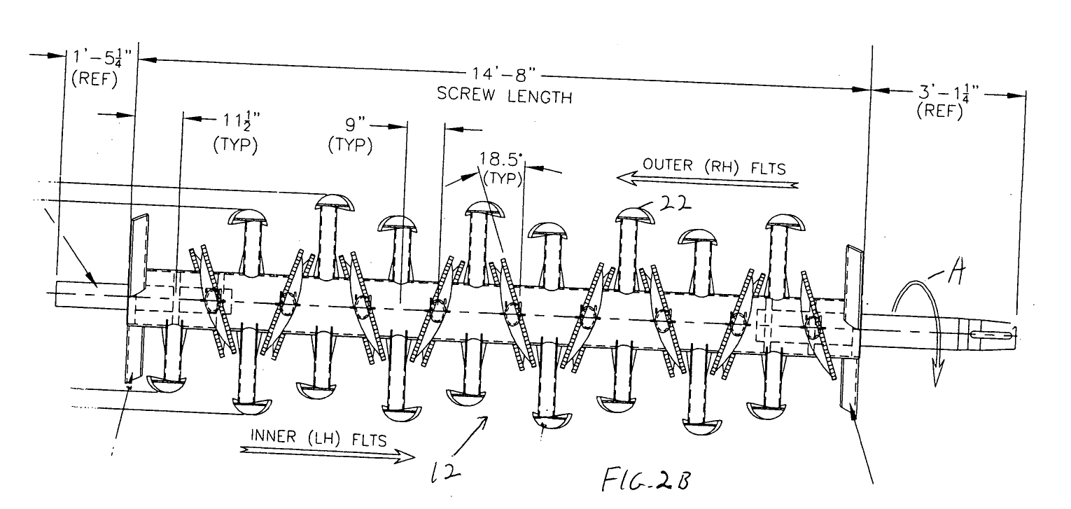

The preferred process equipment is shown schematically in FIG. 1. The mixer, the separator, and the screw conveyor between the separator and the dewatering screen are shown in detail in FIGS. 2 through 4, respectively. As the use of plastic particles is optional, the plastic handling equipment is optional.

In the process accomplished by the equipment of FIG. 1, contaminated soil is brought to the site and weighed and stored. The soil is screened for removal of stones greater than 3/4 inch diameter, which are washed with a high pressure water stream to remove contaminated sediment therefrom. The cleaned stones can be crushed so they are more commercially valuable. The process contemplates a closed-loop water circulation system. The wash water is eventually recirculated to the separator through an activated carbon filter. The activated carbon filter helps to decrease hydrocarbon loading, but is not necessary in the process.

The soil of less than 3/4 inch diameter is loaded into the mixer, which in this example is a batch process. The desired concentration of liquid activator (and the desired concentration of plastic particles when used) are also added to the mixer. Mixing is conducted for about 10 minutes or more. What is necessary is for the activator and contaminated soil (and plastic particles when used) to intimately mix such that the contaminants are removed from the soil by the activator. After sufficient mixing, when plastic particles are used the hydrocarbons are bound to (adsorbed by) the plastic particles.

The separator is a water bath in which the hydrocarbons (or the hydrocarbon-laden plastic particles) float to the surface, and the clean soil sinks to the bottom. This soil is removed by a bottom discharging screw conveyor, and dewatered. The hydrocarbons or plastic particles are skimmed from the surface and removed. The process of FIG. 1 contemplates centrifugation of the pellets (when used) to separate the hydrocarbons and water from the plastic. Alternatively or additionally, the plastic can be compressed into briquettes to remove the hydrocarbons. The plastic can be disposed of or reused as necessary. Yet another alternative would be to incinerate the plastic and contaminants.

The mixer shown in FIG. 2 has a unique mixing paddle design with inside and outside soil paths. The mixer has paddles of two lengths, with each set having its paddle ends angled in different directions. Mixer 10 comprises trough 16 with mixer shaft 12. Mixer shaft 12, FIG. 2B, preferably has paddles of two different lengths. Outer paddles 20 are angled as shown such that, when rotated in the direction of arrow A, they move soil to the left. Inner set of paddles 22 is angled in the other direction so that they move soil to the right. This creates more intimate mixing in less time. This arrangement effectively moves the soil in one direction along the outer portion of the mixer and in another direction along the inner portion of the mixer. This is one particular design of a mixer, but is not a limitation of the invention. Particularly with a batch process, many mixer designs could be used. It would also be possible to design a continuous process with an appropriate mixer.

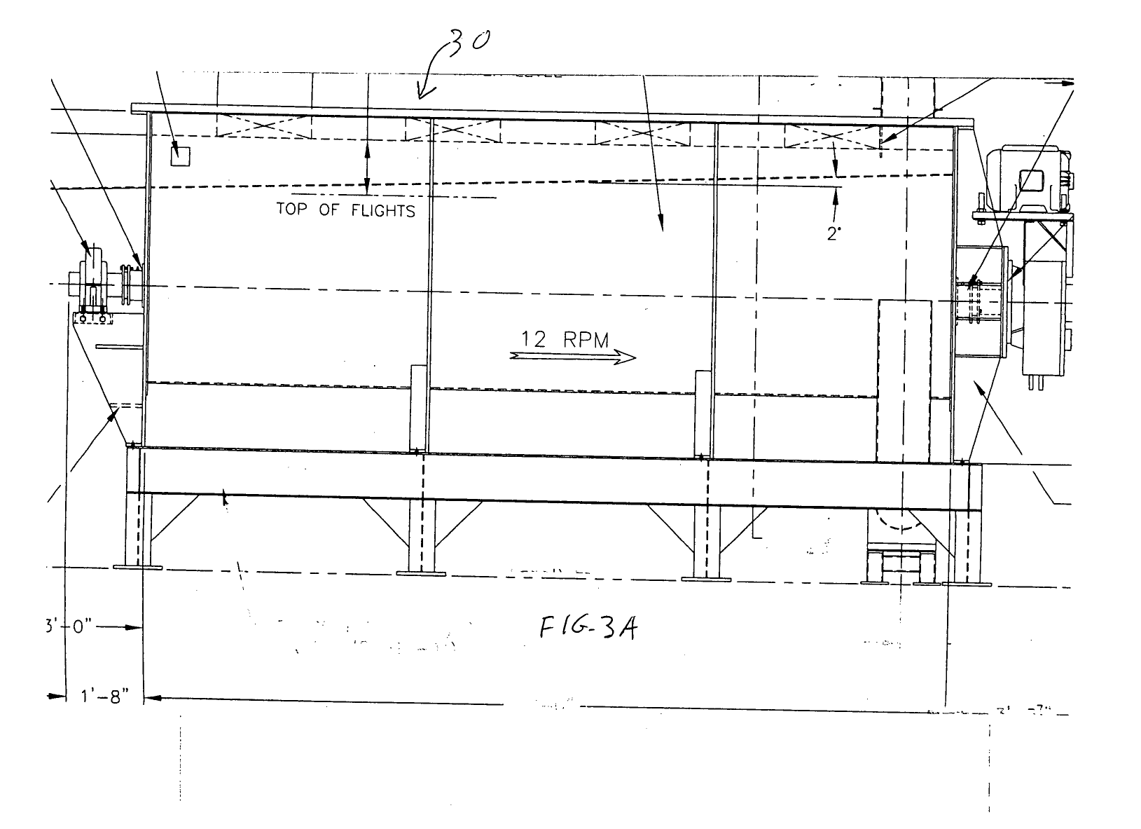

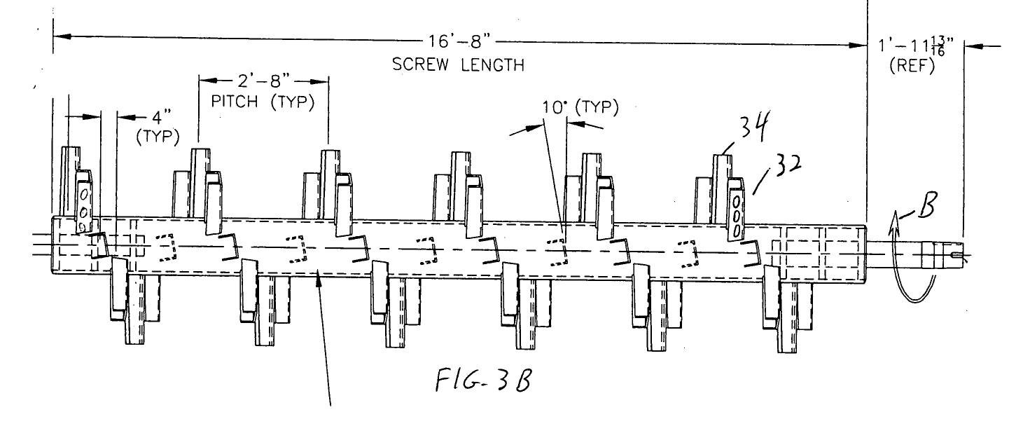

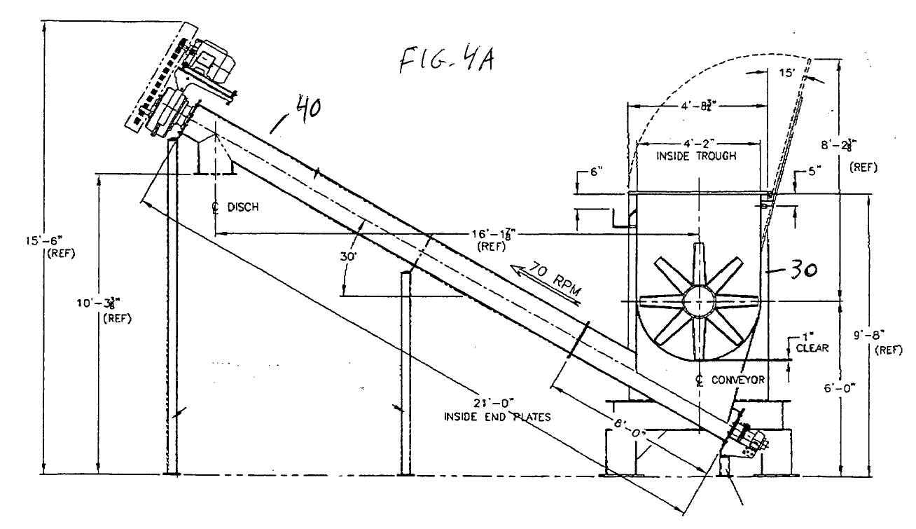

The separator design shown in FIG. 3 is such to sufficiently agitate the water bath so that the hydrocarbons float to the surface. Agitator tank 30, FIG. 3A, is shown as designed to accommodate the use of plastic particles, which is not a limitation of the invention. The design has paddles 34 arranged around agitator shaft 32 as shown in FIGS. 3B and 3C. This design accomplishes a screw that moves plastic particles from right to left in the figure as shaft 32 is rotated in the direction of arrow B. A weir dam at the outlet can assist in separating the floating plastic particles from the water bath, and also can accomplish separation of floating hydrocarbons from the water. When plastic particles are used, the paddles preferably have openings that help to prevent the floating plastic particles from being forced down under the surface. Again, this particular design is not a limitation of the invention, as there are many possible means of stirring or mixing the soil and water. The floating hydrocarbons can be skimmed from the surface.

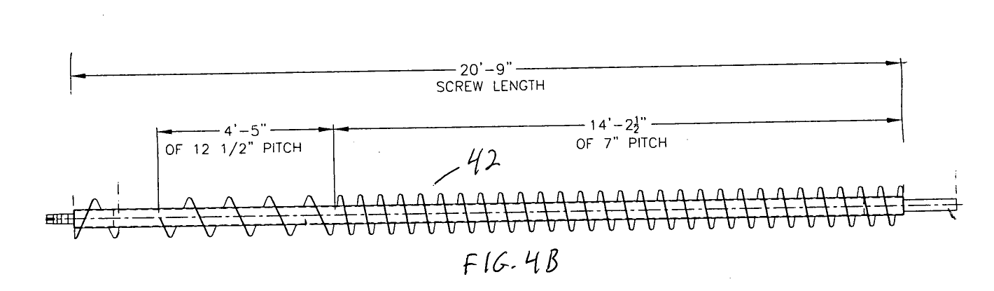

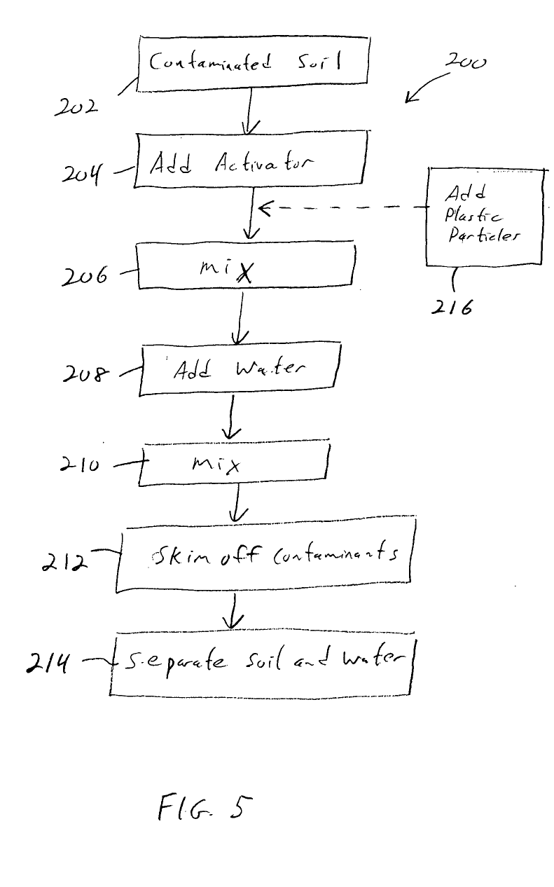

The preferred screw conveyor that moves soil from the bottom of the separator to the dewatering screen is shown in FIGS. 4A and 4B. Screw conveyor 40 is arranged at the outlet of separator 30 and preferably has a variable-pitch screw 42 that moves soil up to a discharge opening that drops the damp soil onto the dewatering screen (not shown in the drawing).

FIG. 5 is a simplified flowchart of the preferred process of the invention. Process 200 begins with supplying contaminated soil 202. The additive or activator is added, step 204. If plastic particles are used, they are added, step 216. Mixing is accomplished, step 206, to thoroughly mix the additive in the soil. This helps to release hydrocarbons from their adhesion to the soil. After thorough mixing, either the mixture is transferred to a water bath, or water is added to the mixture, step 208. Additional mixing, agitation or stirring of the water bath is then accomplished, step 210, which allows the hydrocarbons to float to the surface of the water. When plastic particles are used, much of the hydrocarbon contamination that has been loosened from the soil is preferentially attracted to the plastic particles, which themselves float to the top of the water. The contaminants are then removed from the surface of the water, step 212, and the soil and water are separated, step 214.

Test Results

In the tests set forth below, the different contaminants remediated included gasoline, diesel fuel (same as #2 fuel oil), waste oil & PCB's.

All soil types which are common to New England were used in the bench scale testing. Sand, loam and stone dust were blended together to form a mixture of different particle sizes which represent the three major soil types in New England, sand, silt and clay. Particle sizes ranged from clay (<0.002) mm to sand (2 mm). Since soil in New England typically has an organic component, the loam which was used in the mixture contained peat fragments and various wood constituents.

Four different liquid additives (activators) were used during the bench scale testing: ethanol, methanol, propylene glycol and glycerin USP. A first set of tests used the following activators (additives): a 20% ethanol solution in water (test 1), a 20% glycol solution in water (test 2), a 20% glycerin solution in water (test 3) and a 30% solution consisting of equal amounts of ethanol, glycol and glycerine in water (test 4). Diesel fuel was used as the contaminant during the tests. 45.4 grams of diesel was mixed with 454 grams of the soil mixture. One cup of Styrofoam (2 grams) was used during the tests.

The plastic used during tests 1-4 consisted of #6 polystyrene (Styrofoam) that had been ground up with a food processor. The surface area created by grinding the polystyrene is rough with many edges and sides, which provides substantial surface area for the contaminant to bind to. The polystyrene was open celled, and the cell size was approximately <1 to 3 mm. Other tests set forth herein provide specific information relative to the type and quantity of the polystyrene used.

The activator/water ratios used during tests 1-4 were 10 grams ethanol/40 grams water (20% solution), 10 grams glycol/40 grams water (20% solution), 10 grams glycerin/40 grams water (20% solution), and 5 grams each of ethanol, glycol & glycerin/35 grams of water (30% solution in sum), respectively.

In another set of tests: three activators were used again, ethanol, glycol, glycerin, and a mixture of the three. Two different contaminants were used, diesel fuel and waste oil. One test used ethanol only at a 20% concentration −5 grams of ethanol with 20 grams of water. This test (test 5) used diesel fuel as the contaminant by mixing 45.4 grams of diesel fuel with 454 grams of the soil mixture. Another test (test 6) had a 10% concentration of glycol which consisted of 5 grams of glycol with 45 grams of water. This test used waste oil as the contaminant which consisted of 45.4 grams of waste oil mixed with 454 grams of the soil mixture. Another test (test 7) used all three activators, 10 grams of each mixed with 20 grams of water which was a combined 60% concentration of the three activators combined by volume. In all three tests, one cup (2 grams) of the polystyrene was used.

In another set of tests: (test 8) a 5% solution of ethanol was used which consisted of 2.5 grams of ethanol with 47.5 grams of water, (test 9) a 10% solution with 5 grams of ethanol and 45 grams of water and (test 10) a 30% solution with 15 grams of ethanol and 35 grams of water. Tests were performed using all 50 grams of the mixtures listed above. Diesel fuel was the contaminant by mixing 45.4 grams of diesel fuel with 454 grams of the soil mixture. The tests were repeated using only 25 of the 50 gram mixtures (tests 11, 12 & 13) listed above. 45.4 grams of diesel was mixed with 454 grams of the soil mixture. One cup (2 grams) of the Styrofoam was used during the tests.

In another set of tests: Test 14 consisted of a 10% ethanol solution which consisted of 5 grams of ethanol mixed with 45 grams of water for a total solution of 50 grams. The contaminant was waste oil which was 45.4 grams of waste oil mixed with 454 grams of the soil mixture. One cup (2 grams) of Styrofoam was used. Test 15 consisted of a 20% solution comprised of 10 grams of ethanol and 40 grams of water for a total of 50 grams of solution. Waste oil was the contaminant produced by adding 45.4 grams of waste oil with 454 grams of the soil mixture. One cup (2 grams) of the Styrofoam was used.

In another set of tests: (test 16) consisted of a 20% concentration of propylene glycol produced by adding 10 grams of glycol with 40 grams of water. The contaminant was waste oil with 45.4 grams of waste oil mixed with 454 grams of the soil mixture. One cup (2 grams) of the Styrofoam was used.

In another set of tests: (test 17) consisted of a 10% solution of glycerin USP produced by mixing 5 grams of glycerine with 45 grams of water for a total of 50 grams. The contaminant was waste oil by mixing 45.4 grams of waste oil with 454 grams of the soil mixture. One cup (2 grams of the Styrofoam was used. Test 18 consisted of a 20% solution produced by mixing 10 grams of glycerine with 40 grams of water for a total of 50 grams of solution. The contaminant was waste oil with 45.4 grams of waste oil mixed with 454 grams of the soil mixture. One cup (2 grams) of the Styrofoam was used.

In another set of tests: (test 19) consisted of a 30% concentration produced by adding 5 grams of ethanol, 5 grams of glycol and 5 grams of glycerine with 35 grams of water for a total of 50 grams of solution. The contaminant was waste oil produced by mixing 45.4 grams of waste oil with 454 grams of the soil mixture. One cup (2 grams) of Styrofoam was used.

In another set of tests: (test 20) a 20% ethanol solution produced by mixing 10 grams of ethanol with 40 grams of water for a total of 50 grams of solution was used The contaminant consisted of waste oil and pcb's. One cup (2 grams) of Styrofoam was used.

In another set of tests: (test 21) consisted of a 20% concentration of ethanol produced by mixing 5 grams of ethanol with 20 grams of water for a total of 25 grams of solution. The contaminant was diesel fuel with 45.4 grams of diesel fuel mixed with 454 grams of the soil mixture. One half cup (1 gram) of Styrofoam was used. Test 22 consisted of the same solution and the same contaminant ratios, except a different Styrofoam was. The Styrofoam (“new Styrofoam”) was from a Styrofoam processor and was ground according to their specifications (size < or =0.5 mm). One half cup (1 gram) of the Styrofoam was used.

In another set of tests: (test 23) consisted of a 20% concentration of ethanol produced by mixing 5 grams of ethanol with 20 grams of water for a total of 25 grams of solution. The contaminant was 50 grams of waste oil and 5 grams of gasoline mixed with 454 grams of the soil mixture. One half cup (1 gram) of the new Styrofoam was used. A sample of the treatment water was collected from test 23 for TPH laboratory analysis.

In another set of tests: (test 24) consisted of a 20% ethanol solution produced by mixing 5 grams of ethanol with 20 grams of water for a total of 25 grams of solution. The contaminant was diesel fuel produced by mixing 50 grams of diesel fuel with 454 grams of the soil mixture. One half cup (1 gram) of the new Styrofoam was used. Test 25 consisted of a 20% ethanol solution produced the same way. The contaminant was gasoline by mixing 50 grams of gasoline with 454 grams of the soil mixture. One half cup (3.4 grams) of a different and new, (more dense) blue Styrofoam was used. The blue Styrofoam was ground up in a food processor.

In another set of tests: (test 26) consisted of a 20% solution of ethanol produced by mixing 5 grams of ethanol with 20 grams of water for a total of 25 grams of solution. The contaminant was waste oil by mixing 50 grams of waste oil with 454 grams of the soil mixture. One half cup (1 gram) of the new Styrofoam was used. Test 27 was identical to test 26 in every way except one cup (2 grams) of the new Styrofoam was used instead of one half cup.

In another set of tests: (test 28) consisted of the same 20% solution of ethanol with the contaminant of diesel fuel. 50 grams of diesel fuel was mixed with 454 grams of the soil mixture. Test 28 used one half cup (1 gram) of the new Styrofoam and test 29 was identical to test 28 except one cup (2 grams) of the new Styrofoam was used instead of one half cup.

In another set of tests: (test 30) consisted of an 11% ethanol solution produced by mixing 5 grams of ethanol with 40 grams of water for a total of 45 grams of solution. The contaminant was diesel fuel produced by mixing 50 grams of diesel fuel with 454 grams of the soil mixture. A newer ground #6 Styrofoam was used which was categorized as A-3W by the Styrofoam processing company. Specific details on the grinding process will be described later. One cup (2 grams) of the A-3W Styrofoam was used. Test 31 consisted of a 20% ethanol solution produced by mixing 5 grams of ethanol with 20 grams of water for a total of 25 grams of solution. The contaminant was the same as test 30. One cup (2 grams) of the A-3W Styrofoam was used.

In another set of tests: (test 32) consisted of an 11% solution of ethanol produced by mixing 5 grams of ethanol with 40 grams of water for a total of 45 grams of solution. The contaminant was waste oil produced by mixing 50 grams of waste oil with 454 grams of the soil mixture. One half cup (3.4 grams) of a blue Styrofoam from the Styrofoam processor identified as A-3B was used. The A-3B was ground to the processor's specifications.

In another set of tests: (test 33) consisted of a 20% ethanol solution was produced by mixing 10 grams of ethanol with 40 grams of water for a total of 50 grams of solution. The contaminant was pcb's by mixing 2 grams of pcb's with 454 grams of the soil mixture. One cup (2 grams) of the A-3W Styrofoam was used. A sample of the untreated pcb contaminated soil was collected and submitted to the laboratory for PCB analysis to determine the concentration of pcb's in the soil prior to treatment.

In another set of tests: (test 34) consisted of a 40% ethanol solution was produced by mixing 20 grams of ethanol with 30 grams of water for a total of 50 grams of solution. The contaminant was pcb's by mixing 3 grams of pcb's with 454 grams of the soil mixture. One cup (2 grams) of the A-3W Styrofoam was used. Test 35 consisted of a 60% ethanol solution produced by mixing 30 grams of ethanol with 20 grams of water for a total of 50 grams of solution. The same soil that was used in test 34 was used in test 35 (3 grams of pcb's mixed with 454 grams of the soil mixture). One cup (2 grams) of the A-3W Styrofoam was used.

The ethanol used in all of the above tests was Denatured Alcohol 3 190.

In another set of tests: six different denatured ethanols were used. Test 36 consisted of a 10% ethanol solution was produced by mixing 2.5 grams of SDA-40B with 22.5 grams of water for a total of 25 grams of solution. The contaminant was a mixture of diesel fuel, waste oil and gasoline. 86 grams of diesel fuel, 22 grams of waste oil and 43 grams of gasoline was mixed with 2,724 grams of the soil mixture. One cup of the A-3W Styrofoam was used. Test 37 was identical to test 36 in every way except a different ethanol was used to produce the 10% solution. Ethanol SDA-40-2 was used in test 37. Test 38 was identical in every way except SDA 2B-3TOL was used in test 38. Test 39 was identical in every way except SDA 29-200 was used.

Test 40 was identical in every way except SDA 2B-2 HEP was used. Test 41 was identical in every way except Ethanol 99.9/UN was used.

Tests 42, 43, 44, 45, 46 & 47 were identical to tests 36 through 41 except the ethanol solution used for each of the six different ethanols was decreased to 6%. This was produced by mixing 1.5 grams of each of the six different ethanols with 23.5 grams of water for a total of 25 grams of solution. Each of the six tests, 42 through 47 contained 1.5 grams of the six different ethanols listed above mixed with 23.5 grams of water.

In another set of tests: 60 grams of pcb's were mixed with 2,724 grams of the soil mixture. A sample was collected and submitted to the laboratory for pcb analysis to determine the pcb concentration of the soil prior to treatment. Test 48 consisted of a 40% ethanol solution produced by mixing 20 grams of the SDA-40 B with 30 grams of water for a total of 50 grams of solution. One cup (2 grams) of the A-3W Styrofoam was used. Test 49 consisted of a 20% ethanol solution produced by mixing 10 grams of the SDA-40-2 with 40 grams of water for a total of 50 grams of solution. One cup (2 grams) of the A-3W Styrofoam was used. Test 50 consisted of a 20% ethanol solution produced by mixing 10 grams of SDA 2B-3TOL with 40 grams of water for a total of 50 grams of solution. One cup (2 grams) of the A-3W Styrofoam was used. Test 51 consisted of a 20% ethanol solution produced by mixing 10 grams of the SDA 29-200 with 40 grams of water for a total of 50 grams of solution. One cup (2 grams) of the A-3W Styrofoam was used. Test 52 consisted of a 20% ethanol solution produced by mixing 10 grams of SDA 2B-2HEP with 40 grams of water for a total of 50 grams of solution. One cup (2 grams) of the A-3W Styrofoam was used. Test 53 consisted of a 20% ethanol solution produced by mixing 10 grams of Ethanol 99.9/UN with 40 grams of water for a total of 50 grams of solution. One cup (2 grams) of the A-3W Styrofoam was used.

In another set of tests: 3,636 grams of soil was mixed with 105 grams of diesel fuel, 29 grams of waste oil and 57 grams of gasoline. A sample was collected and submitted to the laboratory for TPH analysis to determine the TPH concentration of the soil prior to treatment. Test 54 consisted of a 4% ethanol solution produced by mixing 1.5 grams of SDA-40-2 with 33.5 grams of water for a total of 35 grams of solution. 1.5 cups (3 grams) of the A-3W Styrofoam was used. Test 55 was identical to test 54 except two cups (4 grams) of the A-3W Styrofoam was used. Test 56 consisted of a 3% ethanol solution produced by mixing 1.5 grams of SDA-40-2 with 43.5 grams of water for a total of 45 grams of solution. 1.5 cups (3 grams) of the A-3W Styrofoam was used. Test 57 was identical to test 56 except two cups (4 grams) of the A-3W Styrofoam was used. Test 58 consisted of a 4% ethanol solution produced by mixing 1.5 grams of SDA 29-200 with 33.5 grams of water for a total of 35 grams of solution. 1.5 cups (3 grams) of the A-3W was used. Test 59 was identical to test 58 except two cups (4 grams) of the A-3W Styrofoam was used. Test 60 consisted of a 3% ethanol solution produced by mixing 1.5 grams of SDA 29-200 with 43.5 grams of water for a total of 45 grams of solution. 1.5 cups (3 g grams) of the A-3W Styrofoam was used. Test 61 was identical to test 60 except two cups (4 grams) of the A-3W Styrofoam was used.

In another set of tests: (test 62) 10 grams of pcb's were mixed with 15 grams of water and then mixed with 454 grams of the soil mixture. A 40% ethanol solution was produced by mixing 20 grams of SDA 29-200 with 30 grams of water for a total of 50 grams of solution. Two cups (4 grams) of the A-3W Styrofoam was used.

In another set of tests: (test 63) 0.25 grams of TCE was mixed with 24.75 grams of water then mixed with 454 grams of the soil mixture. A sample was collected and submitted to the laboratory for TCE analysis to determine the TCE concentration of the soil prior to treatment. 5 grams of ferrous sulfate was mixed with 15 grams of water then mixed into the TCE contaminated soil. 10 grams of 35% hydrogen peroxide was mixed with 10 grams of water then mixed into the TCE contaminated soil. After mixing for ten minutes, the soil was submitted to the laboratory for TCE analysis.

Test 64 comprised contaminating one pound of soil with 30 grams of diesel fuel, 10 grams of gasoline, and 10 grams of waste oil, which resulted in a pretreatment contaminant level of 99,000 parts per million. Three grams of methanol was added to 34.5 grams of water for a total of 37.5 grams of activator. The activator was mixed with the soil in the same manner as in the other tests. One cup (2 grams) of the ground Styrofoam was mixed in, also in the same manner as described above. The Styrofoam was removed after 10 minutes of mixing. Post treatment contaminant levels were 710 ppm.

In tests 1-64, there was no recovery of the contaminant or additive during the bench scale testing. No additive (activator) is expected to be recovered either during bench scale testing, pilot testing with the actual equipment or during commercial operations. The liquid activator will be lost during the mixing of the soil with the activator (and Styrofoam when used). The Styrofoam from the bench scale testing was collected and stored in leak proof containers. All of the recovered contaminant was adsorbed by the Styrofoam. The contaminant could not be removed from the Styrofoam because the amount of Styrofoam used during the bench scale testing was not enough to be able to centrifuge. Recovery of the contaminant can only occur when sufficient quantities of the Styrofoam are generated to be able to centrifuge.

The bench scale tests 1-64 outlined above were performed by taking clean soil and mixing in the virgin contaminants. Quantities identified above were mixed with clean soil in a six quart stainless steel bowl with a Sunbeam hand mixer (Model 2470). After the soil was thoroughly mixed with the specific contaminant, the liquid activator was added, and the soil and activator were again mixed with the hand mixer for approximately one minute. The specific Styrofoam material was then added and the soil, activator and Styrofoam mixture were then mixed again with the hand mixer for approximately nine minutes. The mixture was then flooded by adding water to the stainless steel bowl that it was in. The soil mixture was then agitated by hand to help release the Styrofoam component, which floated to the surface. The Styrofoam component was then skimmed off of the water and collected. The soil was now at the bottom of the stainless steel bowl. The water was then vacuumed off with a water vacuum. The water soaked soil was then dried by placing it in a colander to allow the water to seep out. The somewhat dried soil was then placed in a sample bottle and later analyzed.

Results of Contaminant Levels Before and After Treatment:

| | Pre-Treatment | | Post-Treatment | |
|---|---|---|---|---|
| Test # | In parts per million (“ppm”) | | In parts per million (“ppm”) | |
| Test 1 | 99,000 | ppm | 330 | ppm |
| Test 2 | 99,000 | ppm | 710 | ppm |
| Test 3 | 99,000 | ppm | 810 | ppm |
| Test 4 | 99,000 | ppm | 430 | ppm |
| Test 5 | 99,000 | ppm | 390 | ppm |
| Test 6 | 99,000 | ppm | 910 | ppm |
| Test 7 | 99,000 | ppm | 840 | ppm |
| Test 8 | 99,000 | ppm | 860 | ppm |
| Test 9 | 99,000 | ppm | 650 | ppm |
| Test 10 | 99,000 | ppm | 850 | ppm |
| Test 11 | 99,000 | ppm | 900 | ppm |
| Test 12 | 99,000 | ppm | 860 | ppm |
| Test 13 | 99,000 | ppm | 710 | ppm |
| Test 14 | 99,000 | ppm | 1,300 | ppm |
| Test 15 | 99,000 | ppm | 1,200 | ppm |
| Test 16 | 99,000 | ppm | 930 | ppm |
| Test 17 | 99,000 | ppm | 920 | ppm |
| Test 18 | 99,000 | ppm | 77,000 | ppm |
| Test 19 | 99,000 | ppm | 1,400 | ppm |
| Test 20 | TPH 4,200 ppm | | TPH 850 ppm | |
| | PCBs 850 ppm | | PCBs non detectable | |
| Test 21 | 99,000 | ppm | 630 | ppm |
| Test 22 | 99,000 | ppm | 230 | ppm |
| | | | Treatment water: 0.36 ppm | |
| Test 23 | 108,900 | ppm | 5,652 | ppm |
| | | | Treatment water: 4.6 ppm | |
| Test 24 | 99,000 | ppm | 1,500 | ppm |
| Test 25 | 99,000 | ppm | 2,300 | ppm |
| Test 26 | 72,600 | ppm | 16,000 | ppm |
| Test 27 | 72,600 | ppm | 6,600 | ppm |
| Test 28 | 99,000 | ppm | 1,300 | ppm |
| Test 29 | 99,000 | ppm | 840 | ppm |
| Test 30 | 72,600 | ppm | 760 | ppm |
| Test 31 | 72,600 | ppm | 1,100 | ppm |
| Test 32 | 72,600 | ppm | 11,000 | ppm |
| Test 33 | 296 | ppm | 119 | ppm |
| Test 34 | 634 | ppm | 32.5 | ppm |
| Test 35 | 634 | ppm | 40.1 | ppm |
| Test 36 | 35,000 | ppm | 1,600 | ppm |
| Test 37 | 35,000 | ppm | 620 | ppm |
| Test 38 | 35,000 | ppm | 1,500 | ppm |
| Test 39 | 35,000 | ppm | 990 | ppm |
| Test 40 | 35,000 | ppm | 1,400 | ppm |
| Test 41 | 35,000 | ppm | 800 | ppm |
| Test 42 | 35,000 | ppm | 1,400 | ppm |
| Test 43 | 35,000 | ppm | 1,000 | ppm |
| Test 44 | 35,000 | ppm | 1,100 | ppm |
| Test 45 | 35,000 | ppm | 800 | ppm |
| Test 46 | 35,000 | ppm | 2,100 | ppm |
| Test 47 | 35,000 | ppm | 2,000 | ppm |
| Test 48 | 1,140 | ppm | 189 | ppm |
| Test 49 | 1,140 | ppm | 123 | ppm |
| Test 50 | 1,140 | ppm | 128 | ppm |
| Test 51 | 1,140 | ppm | 55.7 | ppm |
| Test 52 | 1,140 | ppm | 102 | ppm |
| Test 53 | 1,140 | ppm | 92.6 | ppm |
| Test 54 | 27,000 | ppm | 470 | ppm |
| Test 55 | 27,000 | ppm | 1,100 | ppm |
| Test 56 | 27,000 | ppm | 770 | ppm |
| Test 57 | 27,000 | ppm | 1,100 | ppm |
| Test 58 | 27,000 | ppm | 1,600 | ppm |
| Test 59 | 27,000 | ppm | 290 | ppm |
| Test 60 | 27,000 | ppm | 870 | ppm |
| Test 61 | 27,000 | ppm | 1,300 | ppm |
| Test 62 | 346 | ppm | 13.4 | ppm |
| Test 63 | 38.5 | ppm | 1.98 | ppm |
| Test 64 | 99,000 | ppm | 710 | ppm |

In a second series of tests (tests 65-88), the separation was performed without the use of ground plastic particles. In many cases, hydrocarbon removal was as good as or better than when plastic particles were used, as detailed below. In only one case (test 65) another solid additive (wood shavings) was used.

“TPH” as used below stands for “total petroleum hydrocarbons”. “EPH” stands for “extractable petroleum hydrocarbons”. “VPH” stands for “volatile petroleum hydrocarbons”. SDA-29-200 is a product available from Sasol Chemicals North America LLC of Houston, Tex. and typically comprises about 99 percent pure ethanol and about 1 percent ethyl acetate.

In the tests described below in which ground plastic particles were not used, the activator solution acts as a solvent which washes the contaminant off of the soil. The tests indicate that solutions of methanol and ethanol in particular produce the best results when they are in the range of from about 1 percent to about 5 percent solvent concentration. The activator remains in solution and is discharged with any waste water, which can be treated by waste water treatment plants. In the bench-scale tests, rather than transfer the mixture to a water bath, the container in which the mixing occurred is flooded with water (always with additional stirring to cause the loosened contaminants to float to the surface of the water bath). The contaminants floating on the surface of the water bath can be skimmed off, pumped to an oil/water separator, and recovered.

Test 65 comprised mixing 1.6 pounds of soil contaminated with 50 grams of diesel fuel. It was mixed for two minutes to homogenize. A sample was collected to determine the pretreatment contaminant level. A solution of 1.5 grams of methanol and 33.5 grams of water was added. The soil was then mixed with 5 grams of wood shavings for five minutes. The mixture was then flooded with water and then decanted, and a post treatment soil sample was collected for laboratory analysis. A sample of the decanted water was also collected for laboratory analysis.

Pretreatment Level: 13,000 ppm

Post treatment soil Level: 800 ppm

Post treatment water Level: 7.6 ppm

Test 66 comprised mixing 3.5 pounds of soil with 10 grams of diesel fuel, 6 grams of gasoline and 6 grams of waste oil for two minutes until thoroughly homogenized. A pretreatment sample was collected for laboratory analysis. One pound of the premixed soil was mixed with a solution of 3 grams of methanol with 67 grams of water for three minutes. The soil was then flooded with water and decanted. A soil sample was then collected for laboratory analysis.

Pretreat Level: 3,400 ppm

Post treat Level: 270 ppm

Test 67 comprised the same process as test 66, but one pound of the premixed soil was treated in the same manner as above except the soil was flooded after mixing with hot water, then decanted before a soil sample was collected for laboratory analysis.

Pretreat Level: 3,400 ppm

Post treat level: 200 ppm

This same process was followed in test 68, in which one pound of the premixed soil was treated in the same manner as above except that the soil after mixing was flooded with a solution of 10 grams of methanol and 80 ounces of hot water as opposed to plain water. The solution was decanted and a soil sample was collected for laboratory analysis. The results indicate that flooding with an activator solution apparently does not materially assist contaminant removal.

Pretreat Level: 3,400 ppm

Post treat Level: 330 ppm

Test 69 comprised mixing 1.5 pounds of soil with 10 grams of diesel fuel, 6 grams of gasoline and 6 grams of waste oil for two minutes. A sample was collected for laboratory analysis. A solution of 3 grams of methanol and 67 grams of cold water was added to the soil and mixed for three minutes. The soil was then flooded with cold water, decanted and a soil sample was collected. The soil was screened to collect stone for laboratory analysis.

Pretreat Level: 26,000 ppm

Post treat Level: 3,400 ppm

Stone Post treat Level: 790 ppm

Test 70 comprised mixing 4.5 pounds of soil with 30 grams of diesel fuel, 18 grams of gasoline and 18 grams of waste oil for two minutes. A soil sample was collected for laboratory analysis. A solution of 6 grams of methanol and 54 grams of water was added to the soil and mixed for five minutes. The mixture was then flooded and decanted. A soil sample was then collected for laboratory analysis. The post treat soil sample was analyzed for TPH and for ethanol content.

Pretreat Level: 5,600 ppm TPH

Post treat Level: 150 ppm TPH

Post treat Level (methanol): 369 ppm

The same process was followed in tests 71-73. In test 71, the soil/activator mixture was flooded with a solution of 10 grams methanol and 80 ounces of water after being mixed. The solution was decanted and a soil sample was collected to be laboratory analyzed for TPH and methanol.

Pretreat Level: 5,600 ppm TPH

Post treat Level: 350 ppm TPH

Post treat Level (methanol): 655 ppm

Test 72 comprised mixing 3 pounds of soil with 40 grams of diesel fuel, 24 grams of gasoline and 24 grams of waste oil for two minutes. A soil sample was collected for laboratory analysis. One pound of the premixed soil was mixed with a solution of 6 grams of methanol and 54 grams of water, followed by mixing for five minutes. The mixture was then flooded with water, decanted and a soil was collected for laboratory analysis.

Pretreat Level: 14,000 ppm TPH

Post treat level: 1100 ppm TPH

Post treat Level (methanol): 1015 ppm

Test 73 comprised the same process as above, except that the soil was flooded with 10 grams of methanol and 80 ounces of water after being mixed. The solution was then decanted and a soil sample was collected for laboratory analysis.

Pretreat Level: 14,000 ppm TPH

Post treat Level: 370 ppm TPH

Post treat Level (methanol): 1745 ppm

Tests 74-77 were another group of tests. In test 74, 4.5 pounds of soil was mixed with 50 grams of diesel fuel, 20 grams of gasoline and 32 grams of waste oil for two minutes. A soil sample was collected for laboratory analysis. A solution of 0.75 grams of SDA 29-200 denatured ethanol with 34.25 grams of water was mixed with the soil for seven minutes. The soil was then flooded, decanted and a soil sample was collected for TPH and ethanol laboratory analysis.

Pretreat Level: 12,000 ppm TPH

Post treat Level: 210 ppm TPH

Post treat Level (ethanol): <20 ppm

Test 75 comprised mixing one pound of the premixed soil from test 74with a solution of 1.1 grams of SDA 29-200 ethanol and 33.9 grams of water for seven minutes. It was then flooded and decanted and a soil sample was collected for laboratory analysis.

Pretreat Level: 12,000 ppm TPH

Post treat Level: 240 ppm TPH

Post treat Level (ethanol): <20 ppm

Test 76 comprised mixing one pound of this same premixed soil with a solution of 1.5 grams of SDA 29-200 ethanol and 33.5 grams of water for seven minutes. It was flooded, decanted and a soil sample was collected for laboratory analysis.

Pretreat level: 12,000 ppm TPH

Post treat Level: 390 ppm TPH

Post treat level (ethanol): 54.1 ppm

Test 77 comprised mixing one pound of this same premixed soil with a solution of 3 grams of SDA 29-200 ethanol and 32 grams of water for seven minutes. It was then flooded, decanted and a soil sample was collected for laboratory analysis.

Pretreat level: 12,000 ppm TPH

Post treat level: 650 ppm TPH

Post treat Level (ethanol): 35.7 ppm

Another set of tests is 78-82. In test 78, 5.5 pounds of soil was mixed with 123 grams of diesel fuel, 49 grams of gasoline and 78 grams of waste oil for two minutes. A soil sample was taken for laboratory analysis. A solution of 0.75 grams of SDA 29-200 ethanol and 34.25 grams of water was mixed with the soil for seven minutes. It was then flooded, decanted, and a soil sample was collected for TPH and ethanol laboratory analysis.

Pretreat Level: 21,000 ppm TPH

Post treat Level: 390 ppm TPH

Post treat level (ethanol): 44 ppm

In test 79, one pound of the premixed soil from test 78 was mixed with a solution of 0.75 grams of SDA 29-200 ethanol and 34.25 grams of water. It was then sprayed with a solution of 2 grams Simple Green (an all-purpose cleaner containing ethylene glycol monobutyl ether, butyl cellusolve, butyl glycol and glycol ether, available from Sunshine Makers, Huntington Harbor, Calif.) and 24 grams of water. The entire mixture was then mixed for seven minutes, flooded, decanted and a sample was collected for laboratory analysis.

Pretreat Level: 21,000 ppm TPH

Post treat level: 560 ppm TPH

Post treat Level (ethanol): 26.2 ppm

In test 80, one pound of this same premixed soil was mixed with a solution of 1.1 grams of SDA 29-200 ethanol and 33.9 grams of water for seven minutes. It was flooded, decanted and a sample was collected for laboratory analysis.

Pretreat Level: 21,000 ppm TPH

Post treat Level: 450 ppm TPH

Post treat Level (ethanol): 103 ppm

In test 81, one pound of this same premixed soil was mixed with a solution of 1.5 grams of SDA 29-200 ethanol and 33.5 grams of water for seven minutes. It was flooded, decanted and a sample was collected for laboratory analysis.

Pretreat Level: 21,000 ppm TPH

Post treat Level: 1100 ppm TPH

Post treat Level (ethanol): 158 ppm

In test 82, one pound of this same premixed soil was mixed with a solution of 3 grams of SDA 29-200 ethanol for seven minutes. It was flooded, decanted and a sample was collected for laboratory analysis.

Pretreat Level: 21,000 ppm TPH

Post treat Level: 310 ppm TPH

Post treat Level (ethanol): 279 ppm

Another group of tests was tests 83-85. In test 83, 3.5 pounds of soil was mixed with 128 grams of diesel fuel, 1 gram of gasoline and 31 grams of waste oil for two minutes. A sample was collected for laboratory analysis. One pound of the pre mixed soil was mixed with 0.75 grams of SDA 29-200 ethanol and 49.25 grams of water for five minutes. It was then flooded, decanted and a sample was collected for laboratory analysis. A different laboratory method (EPH/VPH) was used for analysis instead of TPH in order to determine specific carbon fractions present in the pre and post samples.

| | |
|---|---|
| Pretreat Level (EPH): Total EPH constituents plus | 27,121 ppm |
| target compounds | |
| Post treat Level (EPH): Total EPH constituents plus | 1,438 ppm |
| target compounds | |
| Pretreat Level (VPH): Total VPH constituents plus | 69,524 ppm |
| target compounds | |
| Post treat Level (VPH): Total VPH constituents plus | 1,345.57 ppm |
| target compounds | |
| Post test (ethanol): | 84 ppm |

In test 84, one pound of the premixed soil from test 83 was mixed with a solution of 0.50 grams of SDA 29-200 ethanol for five minutes. It was flooded, decanted and a sample was collected for laboratory analysis.

| | |
|---|---|
| Pretreat Level (EPH): Total EPH plus target compounds | 27,121 ppm |
| Post treat Level (EPH) Total EPH plus target compounds | 1,534 ppm |
| Pretreat Level (VPH): Total VPH plus target compounds | 69,524 ppm |
| Post treat Level (VPH): Total VPH plus target | 3,950.66 ppm |
| compounds | |
| Post treat (ethanol): | 156 ppm |

In test 85, one pound of this same premixed soil was mixed with a solution of 0.50 grams of SDA 29-200 ethanol and 49.50 grams of water for five minutes. It was flooded, decanted and a sample was collected.

| | |
|---|---|
| Pretreat Level (EPH): Total EPH plus target compounds | 27,121 ppm |
| Post treat Level (EPH): Total EPH plus target compounds | 8,649.9 ppm |
| Pretreat Level (VPH): Total VPH plus target compounds | 69,524 ppm |
| Post treat Level (VPH): Total VPH plus target | 2,088.41 ppm |
| compounds | |
| Post treat Level (ethanol): | 50 ppm |

Another group of tests was tests 86-88. In test 86, 1.5 pounds of soil were mixed with 49.75 grams of diesel fuel, 0.45 grams of gasoline and 13.2 grams of waste oil for two minutes. A sample was collected for laboratory analysis. A solution of 0.75 grams of SDA 29-200 ethanol and 64.75 grams of water were mixed with the soil for five minutes. It was then flooded, decanted and a sample was collected for laboratory analysis.

| | |
|---|---|
| Pretreat Level (EPH): Total EPH and target compounds | 29,945.8 ppm |
| Post treat Level (EPH): Total EPH and target compounds | 3,620.8 ppm |
| Pretreat Level (VPH): Total VPH plus target compounds | 5,832.6 ppm |
| Post treat Level (VPH): Total VPH plus target | 759.71 ppm |
| compounds | |
| Post treat TPH Level: | 1,700 ppm |
| Post treat Level (ethanol): | 126 ppm |

In test 87, 2.5 pounds of soil from test 86 were mixed with 91 grams of diesel fuel, 0.7 grams of gasoline and 22 grams of waste oil for two minutes. A sample was collected for laboratory analysis. One pound of the premixed soil was mixed with a solution of 0.75 grams of SDA 29-200 ethanol and 64.25 grams of water for five minutes. It was then flooded, decanted and a sample was collected.

| | |
|---|---|
| Pretreat Level (EPH): Total EPH and target compounds | 44,571.2 ppm |
| Post treat (EPH): Total EPH and target compounds | 2,933 ppm |
| Pretreat Level (VPH): Total VPH and target compounds | 6,878.7 ppm |
| Post treat Level (VPH): Total VPH and target compounds | 549.83 ppm |
| Post treat Level (TPH): | 3,200 ppm |
| Post treat Level (ethanol): | 180 ppm |

In test 88, one pound of this same premixed soil was mixed with a solution of 0.85 grams of SDA 29-200 ethanol and 59.15 grams of water for five minutes. It was then flooded, decanted and a sample was collected for laboratory analysis.

| | |
|---|---|
| Pretreat Level (EPH): Total EPH and target compounds | 44,571.2 ppm |
| Post treat Level (EPH): Total EPH and target compounds | 3,259 ppm |
| Pretreat Level (VPH): Total VPH and target compounds | 6,878.7 ppm |
| Post treat Level (VPH): Total VPH and target compounds | 648.08 ppm |
| Post treat Level (TPH): | 2,600 ppm |
| Post treat Level (ethanol): | 119 ppm |

Test 89 and 90 were performed not on the bench but using the equipment shown in the figures. In test 89, the equipment was set-up with the mixer being fed by a hopper conveyor. Three cubic yards of soil (approx. 4.5 tons) was mixed with 20 gallons of diesel fuel. The soil was allowed to mix in the mixer with the diesel fuel for five minutes to allow for a homogenous mixture with the contaminant. A sample was taken after mixing for laboratory analysis of pretreatment contaminant levels. The diesel-contaminated soil was then mixed with five gallons of methanol, ninety gallons of water and 50 pounds of the ground Styrofoam discussed above. After mixing thoroughly for ten minutes, the soil was released from the bottom of the mixer onto a beaver tail conveyor, and conveyed to the agitated water bath. The saturated soil was then conveyed out of the agitated water bath by the screw conveyor at the opposite end of the agitated water bath where the soil first entered the water bath. The discharged saturated soil was then dropped onto a Derrick dewatering screen (Model 2E48-90W-3A) Dual motor screening machine. The treated soil consisted of two fractions, one being the soil which passed over the screens and off the dewatering screen, and the other being the silt which passed through the screens of the dewatering screens. The dewatering screen had three screen panels, the first was a 0.18 MM tapered parallel slot, and the last two had 0.50 MM slots. Two soil samples were collected. One from the soil discharged off of the screen, and the other collected form below the screen (silt).

Pretreat contaminant Level: 13,000 ppm

Post treat silt: 65 ppm

Post treat over screen material: 99 ppm

For test 90, another test was done with this same equipment. This time approx. 8.5 cubic yards (13 tons) of soil was mixed with fifty gallons of diesel fuel in the same manner as the previous test. 15 gallons of methanol and 270 gallons of water were added. The same process was used with the same equipment and time sequencing as the previous test. No silt sample was collected. Only soil that passed over the dewatering screen was collected for laboratory analysis.

Pretreat Level: 6,700 ppm

Post treat Level: 260 ppm

Other embodiments will occur to those skilled in the art and are within the following claims:

What is claimed is:

1. A process for removing hydrocarbon contaminants from contaminated soil, comprising:
adding to the soil at least one additive selected from the group consisting of alcohols and polyols;
mixing, to contact the components together, to cause the contaminants to be at least partially removed from the soil by the additives; and
removing at least some of the hydrocarbon contaminants by flotation.

2. The process of claim 1, further comprising adding cell-containing plastic particles before the mixing step.

3. The process of claim 2, wherein the plastic particles comprise mechanically ground foamed polystyrene.

4. The process of claim 1, wherein the plastic is open-celled.

5. The process of claim 1, wherein the additive comprises a methanol-based solution.

6. The process of claim 5, wherein the methanol has a concentration in the range of about 1 to about 12 percent.

7. The process of claim 1, wherein the additive comprises an ethanol-based solution.

8. The process of claim 7, wherein the ethanol has a concentration in the range of about 1 to about 60 percent.

9. The process of claim 1, wherein the additive comprises a propylene glycol-based solution.

10. The process of claim 1, wherein the additive comprises a glycerin-based solution.

11. The process of claim 1, wherein the additive comprises a solution of ethanol, glycol and glycerine.

12. A process for removing hydrocarbon contaminants from contaminated soil, comprising:
adding to the soil at least one additive selected from the group consisting of methanol-based and ethanol-based solutions;
mixing, to contact the components together, to cause the contaminants to be at least partially removed from the soil by the additives;
stirring the soil-additive mixture in a water bath to cause at least some of the hydrocarbon contaminants to float to the top of the water bath; and
removing floating contaminants from the water bath.
